(19) United States
(12) Patent Application Publication
(10) Pub. No.: US 2011/0123823 A1
(43) Pub. Date: May 26, 2011

(54) METHOD OF JOINING GRAPHITE FIBERS TO A SUBSTRATE

(75) Inventor: Durwood M. Beringer, Suffield, CT (US)

(73) Assignee: HAMILTON SUNDSTRAND CORPORATION, Windsor Locks, CT (US)

(21) Appl. No.: 12/623,705

(22) Filed: Nov. 23, 2009

(51) Int. Cl. B32B 15/04; B23K 31/02; B32B 9/04; B32B 15/20

(52) U.S. Cl. 428/634; 228/122.1; 428/408

(57) ABSTRACT

Disclosed is a method of assembling a metallic-graphite structure (10) including arranging one or more layers of graphite fiber material (12) and locating at least one metallic sheet (18) adjacent to the one or more layers of graphite fiber material (12). The at least one metallic sheet (18) is secured to the one or more layers of graphite fiber material (12) via brazing. Further disclosed is a metallic-graphite structure (10) including one or more layers of graphite fiber material (12) and at least one metallic sheet (18) located adjacent to the one or more layers of graphite fiber material (12). The at least one metallic sheet (18) is secured to the one or more layers of graphite fiber material (12) via brazing.

### BACKGROUND OF THE INVENTION

The subject matter disclosed herein generally relates to graphite fibers joined to a substrate material. More particularly, the subject matter disclosed herein relates to graphite fiber and substrate structures for heat exchanger systems.

Fibercore graphite is a material utilized, for example, in heat exchange applications. The material comprises an array of graphite fibers with a filler of a wax material therebetween. Large pieces of the fibercore are typically bonded to a desired surface, for example, an aluminum component, via an adhesive. Thermal mismatch issues are common between bulk graphite and graphite foam when joined to a metallic substrate. Fibercore graphite is not a monolithic structure and as such accommodates the thermal mismatch by translating with the substrate during thermal processing. Further, the thickness of the fibercore, which is relative to a length of the graphite fibers in the fibercore, is limited due to capability of graphite fiber production. The relatively thin fibercore material is fragile and is subject to breakage and damage when handling and/or shaping by machining or the like into desired shapes. The art would well receive a more robust structure of fibercore, which is not as sensitive to handling and/or other processing and which improves the thermal mismatch issues that exist in current structures.

### BRIEF DESCRIPTION OF THE INVENTION

According to one aspect of the invention, a method of assembling a metallic-graphite structure includes arranging one or more layers of graphite fiber material and locating at least one metallic sheet adjacent to the one or more layers of graphite fiber material. The at least one metallic sheet is secured to the one or more layers of graphite fiber material via brazing.

According to another aspect of the invention, a metallic-graphite structure includes one or more layers of graphite fiber material and at least one metallic sheet located adjacent to the one or more layers of graphite fiber material. The at least one metallic sheet is secured to the one or more layers of graphite fiber material via brazing.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of an embodiment of a graphite fiber heat dissipative structure;

FIG. 2 is a cross-sectional view of another embodiment of a graphite fiber heat dissipative structure; and

FIG. 3 is a cross-sectional view of yet another embodiment of a graphite fiber heat dissipative structure.

The detailed description explains embodiments of the invention, together with advantages and features, by way of example with reference to the drawings.

### DETAILED DESCRIPTION OF THE INVENTION

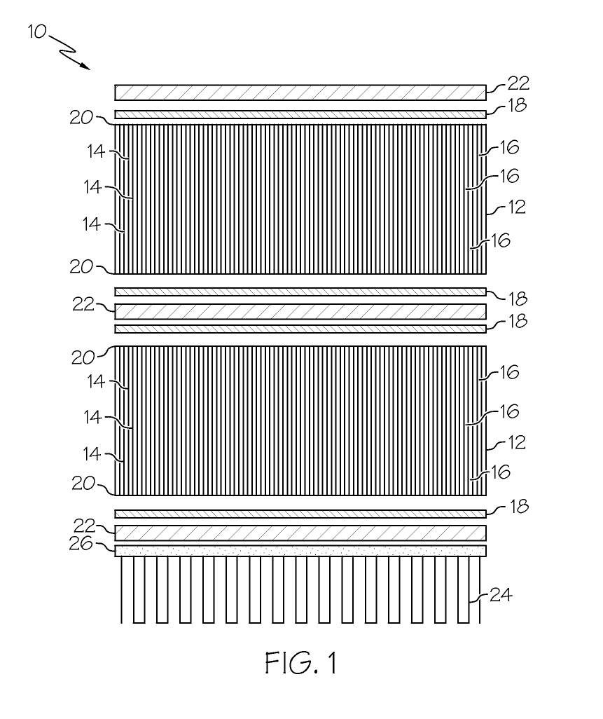

Shown in FIG. 1 is a cross-sectional view of an embodiment of a multi-layer fibercore graphite structure 10. The embodiment of FIG. 1 includes two fibercore graphite layers 12, but it is to be appreciated that other quantities of fibercore graphite layers 12, for example, one, three, five or more fibercore graphite layers 12 may be utilized in the structure 10. Each fibercore graphite layer 12 includes a plurality of graphite fibers 14, with the volume between the graphite fibers 14 occupied by a volume of wax 16. In one embodiment, the graphite fibers 14 are approximately 0.40 inches (1.0 cm) long, which results in a fibercore graphite layer 12 thickness of 0.40 inches (1.0 cm). It is to be appreciated, though, that other lengths of graphite fibers 14, resulting in other thicknesses of fibercore graphite layers 12, may be utilized. In embodiments where longer graphite fibers 14 are utilized, the fibers may be arranged with a greater density to resist buckling of the graphite fibers 14.

A layer of braze filler 18, for example a BNi-2 filler, is utilized between the fibercore graphite layers 12 to join the layers of fibercore graphite 12. In this embodiment, a length of the graphic fibers 14 of the fibercore graphite layer 12 extends substantially from one layer of filler 18 to another layer of filler 18. In some embodiments, at each upper and lower end 20 of the assembly, a metallic sheet 22, which may be a nickel or other suitable material, is brazed to the filler 22. Additionally, in some embodiments, a metallic sheet 22 may be disposed between graphite layers 12 in the assembly. In embodiments where more than one fibercore graphite layer 12 is utilized, brazing of all layers 12 together may be accomplished in a single step. While the embodiments illustrated utilize a nickel metallic sheet 22 and a BNi-2 filler 18, in some embodiments, the metallic sheet 22 may be other nickel-based brazing alloys or of an alloy of titanium and titanium-containing fillers 18 may be utilized therewith.

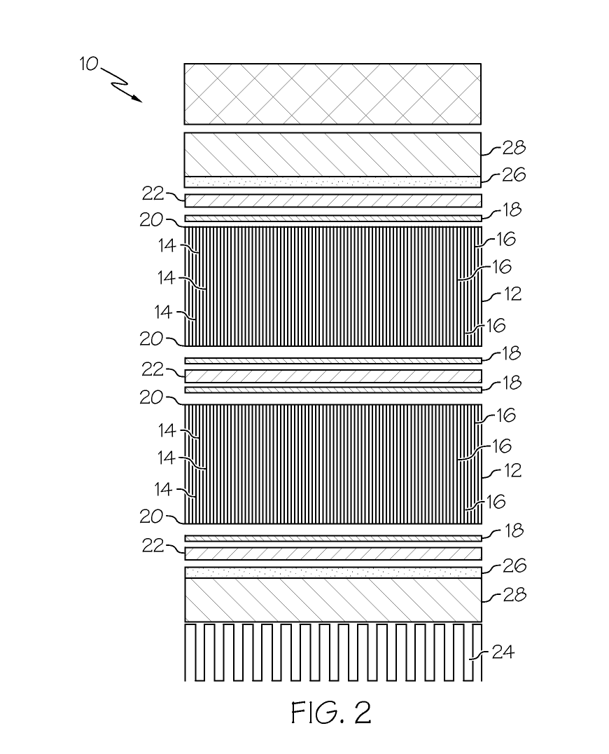

The sandwich structure is brazed to a substrate 24 formed from, for example, an aluminum material. Alternatively, the substrate 24 may be formed from other materials, such as stainless steel or nickel alloy where increased fluid compatibility is required, for example in a corrosive fluids environment. Brazing of the metallic sheet 22 to the substrate 24 is accomplished via an aluminum braze alloy 26 disposed between the metallic sheet 22 and the substrate 24. In some embodiments, as shown in FIG. 2, an endsheet 28 is located between the metallic sheet 22 and the substrate 24. The endsheet 28 is formed of, for example, aluminum multiclad, and is brazed to the metallic sheet 22 and the substrate 24 using aluminum braze alloy 26.

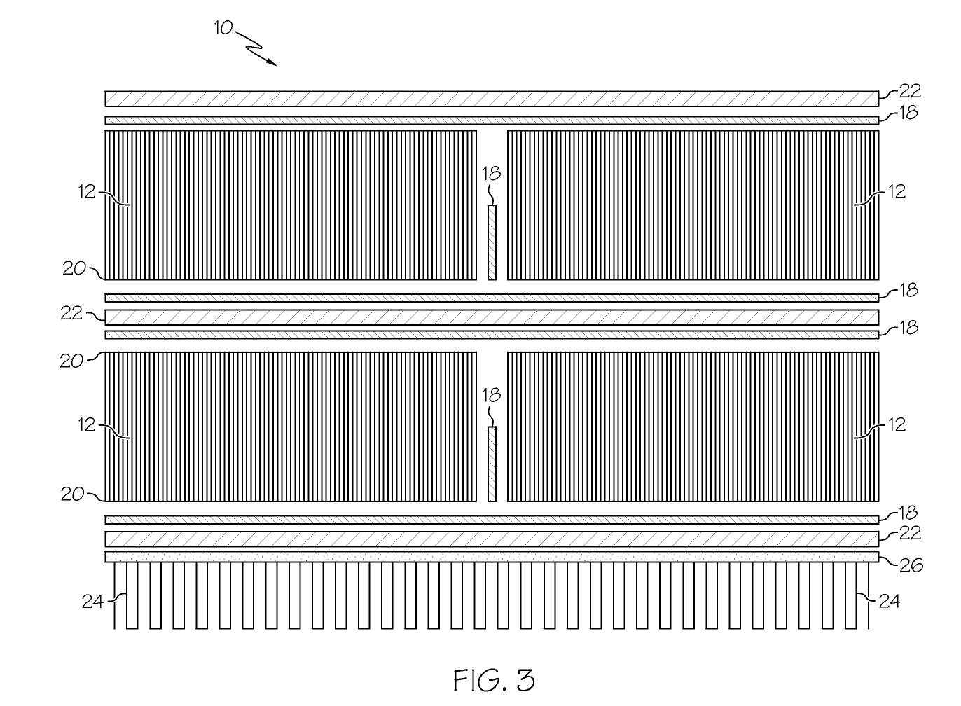

In some embodiments, as shown in FIG. 3, two or more fibercore graphite layers 12 may be arranged side-to-side and joined via brazing. In these embodiments, the metallic sheet 22 is omitted and only filler 18 is located between sides 30 of adjacent fibercore graphite layers 12. To accomplish the brazing operation, the filler 18 is located between the metallic sheet 22 and each fibercore graphite layer 12, wetting the graphite fibers 14. When joining fibercore graphite layers 12 side-to-side, the filler 18 extends only partially along the length of the graphite fibers 14. Leaving a portion of the joint uncovered by filler 18 allows for more efficient filling of the gaps between graphite fibers 14 with wax 16 in later processing after the fibercore graphite layers 12 are joined. Location of filler 18 may be alternated throughout an assembly to promote flow of the wax 16 through the fibercore graphite layer 12 when filled. As shown in FIG. 3, multiple layers may be constructed once the graphite layers 12 are joined side-to-side. The stack may include a metallic sheet 22 at the top and/or bottom of the assembly, and optionally a metallic sheet 22 may be disposed between fibercore graphite layers 12. In effect, a large brazed assembly of fibercore graphite layers 12, extending both in thickness and in length/width may be constructed.

The joining of ends of graphite fibers 14 to a metallic sheet 22 into the sandwich structure results in an effectively longer graphite fiber 14 length. The taller fibercore height may be packaged into a more cubic structure (vs. a flat plate) which requires less external support during vibrational loading. Further, the metallic sheet 22/fibercore graphite layer 12 structure is less susceptible to handling damage and can be shaped by a variety of processes, for example, electrical discharge machining (EDM), to produce desired shapes to close tolerances.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of assembling a metallic-graphite structure (10) comprising:
arranging one or more layers of graphite fiber material (12);
locating at least one metallic sheet (18) adjacent to the one or more layers of graphite fiber material (12); and
securing the at least one metallic sheet (18) to the one or more layers of graphite fiber material (12) via brazing.

2. The method of claim 1 comprising securing the at least one metallic sheet (18) to a heat exchanger (24) via brazing.

3. The method of claim 2 wherein the heat exchanger (24) is formed from aluminum or an aluminum-containing alloy.

4. The method of claim 1 wherein the one or more layers of graphite material (12) is one or more layers of fibercore graphite.

5. The method of claim 1 wherein a length of a plurality of graphite fibers (14) in the graphite fiber material (12) extends from a first metallic sheet (18) of the at least one metallic sheet (18) to a second metallic sheet (18) of the at least one metallic sheet (18).

6. The method of claim 5 comprising stacking two or more layers of graphite fiber material (12) to increase an effective length of the plurality of graphite fibers (14).

7. The method of claim 6 wherein at least one metallic sheet (18) is disposed between adjacent layers of the two or more layers of graphite fiber material (12).

8. The method of claim 1 wherein the at least one metallic sheet (18) is formed from a nickel material.

9. The method of claim 1 wherein the at least one metallic sheet (18) is formed from a material containing titanium.

10. A metallic-graphite structure (10) comprising:
one or more layers of graphite fiber material (12);
at least one metallic sheet (18) adjacent to the one or more layers of graphite fiber material (12) and secured thereto by brazing.

11. The metallic-graphite structure (10) of claim 10 comprising a heat exchanger (24) secured to the at least one metallic sheet (18) via brazing.

12. The metallic-graphite structure (10) of claim 11 wherein the heat exchanger (24) is formed from aluminum or an aluminum-containing alloy.

13. The metallic-graphite structure (10) of claim 10 wherein the one or more layers of graphite material (12) comprises a plurality of graphite fibers (14) interposed with a volume of wax material (16).

14. The metallic-graphite structure (10) of claim 10 wherein a length of the plurality of graphite fibers (14) extends from a first metallic sheet (18) of the at least one metallic sheet (18) to a second metallic sheet (18) of the at least one metallic sheet (18).

15. The metallic-graphite structure (10) of claim 14 comprising two or more layers of graphite fiber material (12) stacked to increase an effective length of the plurality of graphite fibers (14).

16. The metallic-graphite structure (10) of claim 15 wherein at least one metallic sheet (18) is disposed between adjacent layers of the two or more layers of graphite fiber material (12).

17. The metallic-graphite structure (10) of claim 10 wherein the at least one metallic sheet (18) is formed from a nickel material.

18. The metallic-graphite structure (10) of claim 10 wherein the at least one metallic sheet (18) is formed from a material containing titanium.
